(19) United States
(12) Patent Application Publication
(10) Pub. No.: US 2003/0062020 A1
(43) Pub. Date: Apr. 3, 2003

(54) Balanced rotary internal combustion engine or cycling volume machine

(76) Inventor: Paul D. Okulov, Lachine (CA)

Correspondence Address: Dr. Paul D. Okulov, 3574 Blvd. St-Joseph, Lachine, QC, H8T 1P7, CA

(21) Appl. No.: 10/160,072

(22) Filed: Jun. 4, 2002

Related U.S. Application Data
(60) Provisional application No. 60/295,577, filed on Jun. 5, 2001.

(51) Int. Cl. F02B 53/00

(52) U.S. Cl. 123/241

(57) ABSTRACT

Balanced rotary cycling machine suitable for use as an internal combustion engine, compressed gas or steam engine, compressor or pump as well as jet propulsion engine is disclosed herein. The rotor assembly consists of four articulating pistons where the opposite pistons are linked with each other by pivoted rods comprising together a parallelogram mechanism and therefore eliminating a need for pivots between pistons. The rotor assembly is rotating inside or outside of circular or non-circular stator depending on the configuration chosen. Variety of apparatuses for variation of the shape of four piston assembly during its rotating cycle are also disclosed herein as well as detailed descriptions of preferred embodiments, including a four cycle internal combustion engine with circular stator, boat engine with polymer parts and four cycle automobile rotary engine with oil pan. In addition, a method of operation of external rotary combustion engine employing a high pressure compressor and an external combustion chamber is disclosed. The invention also teaches a novel lubrication system for rotary automobile engine providing low emissions. The engine has few moving parts, simplified circular or semicircular stator shape and utilizes simple and effective sealing techniques similar to ones employed in Wankel type engines. It is fully balanced, has few moving parts, has very low friction and heat losses due to elimination of pivots at the end of the pistons and employment of optimal configuration combustion chamber with lower area of the surfaces exposed to hot gases.

### BACKGROUND OF THE INVENTION

This invention relates in general to rotary internal combustion engines and more specifically to engines utilizing variable shape rotor known from the earliest prior art as Werner (U.S. Pat. No. 716,970) type and opposite to the Wankel type rotary engines with fixed shape rotor and epitrochoidal shape stator. The device also relates to compressors, pumps, vacuum machines, steam or compressed gas engines and other cycling machines.

In present invention, during the rotation cycle, the rotor pivoting blades or pistons align alternatively in a lozenge and a square configuration so that the volume between the blades itself, side walls and the stator is changing which allows to create a cycling machine.

Rotary engines and cycling machines based on the principle of Edward H. Werner's invention (FIG. 9) of 1902 (U.S. Pat. No. 716,970) and further inventions developed in greater details (FIG. 7) by Alfred Jordan (U.S. Pat. Nos. 3,295,505; 3,369,529; 4,181,481) as well as other cycling machines with variable shape rotors are well known from the prior art.

According to the German Pat. No. 1,295,569 a rotary internal combustion engine is known, in which two pistons are provided, which are connected to the shaft by means of two diametrically opposite arms fixedly connected to the shaft.

Most recent realization of such cycling machine utilizing Werner's principle and described in U.S. Pat. No. 6,164,263 (FIG. 8) employs roll carriages pivotally connected to the ends of the blades and therefore creating a lateral support for the rotor and simultaneously providing a cam surface for the rotor shape deformation. In this device an additional variation of the volume between the blades, side covers and a stator is achievable due to variation in relative position of the carriages and blades.

Similar configuration indeed is well known from the prior art including U.S. patents by Jordan, Ishida and Niemland. These devices however do not employ rolls at the end of sealing carriages except as in the U.S. Pat. No. 3,387,596 by Niemand where rolls are used in combination with cam surface for deformation of the shape of four link blades' parallelogram. This cam though was not part of the combustion chamber which provided improved reliability of the device compared to U.S. Pat. No. 6,164,263.

Parallelogram mechanisms for creating reciprocating movement of the pistons are known from the U.S. Pat. No. 5,203,295 by Alexander. Multiple application of unique properties of the parallelogram mechanism are also known, for instance from PCT WO 09105990 A1 by Okulov. However the common disadvantage exists that the pivoting blades or links arranged in such configuration are extremely difficult to seal at the pivoting ends.

Different sealing techniques and methods are described in details in the U.S. Pat. Nos. 3,950,017; 3,690,791; 3,918,41; 4,296,936, etc. Particularly, several different types of seals are needed to provide adequate sealing of the device similar to U.S. Pat. No. 6,164,263 which greatly complicates design and makes it unreliable. In addition, the complicated shape of the parts and greater surface area of combustion chamber both determine high thermal losses and lower efficiency for this type of engines. Eliminating roll carriages in order to create simpler shape for the combustion chamber (or considering its size near zero) brings such design back to the devices like ones described in a U.S. Pat. No. 3,918,415.

The geometry and numerous configurations of the rotor and stator shapes were detailed in U.S. Pat. Nos. 3,950,117 and 5,288,217 for different types of variable shape rotors. The shape employed in the U.S. Pat. No. 6,164,263 is generally described in prior art and employing non deformable rotor (FIG. 10) having one to four pivoted carriages running in a stator of square or other polygon like with rounded corners shape.

All these engines have an advantage of being near vibrations free contrary to the Wankel and other type of engines with fixed shape rotor or unbalanced pistons. Disadvantages of the engines however exists that seals at the pivoting ends of the blades are complicated and there are still high friction losses due to the significant stress produced by gas pressure and complex shape of the seals and joints.

In addition the rolls of the carriages being part of the combustion chamber are exposed to high temperature combustion gases and are suffering deposition of residue products or plaque from the combustion process. Very complicated configuration of the combustion chamber creates excessive heat transfer to its parts due to large surface area predetermined by the geometry of the pistons (blades.) Due to the higher surface area of the combustion chamber/s relatively to its volume/s, there is more residue from the non burnt film of the fuel on it. As in most rotary engines, due to centrifugal action of the rotating rotor forcing the lubricator oil to enter the exhaust, a tendency of having higher overall engine emissions still exists.

There are also well known devices (so-called “cat and mouse” or scissors type engines) realized in a variety of configurations and utilizing principle of creating cycling volumes between rotating inside the circular or toroidal housing pistons or blades. The disadvantage of these engines is a necessity for creating an external mechanism for variation of the relative position of the pistons. These devices include cams, oval gears, rotating links mechanisms (Rice), etc. Another known type of balanced rotary engines are devices employing cylinders and pistons arranged in a circle and having an activating pistons movement cam with rotating shaft.

Other engines are represented by concepts proposed in a prior art and including a pressure energy converter, rotary engine or compressor as in U.S. Pat. Nos. 4,068,985, 3,996,899; a rotary disk engine as in the U.S. Pat. No. 5,404,850; a rotary planetary motion engine as in U.S. Pat. No. 5,399,078; a rotary detonation engine as in the U.S. Pat. 4,741,154; a rotary combustion engine as in DE patent 2,448,828, U.S. Pat. Nos. 3,933,131, 4,548,171, 5,036,809; the Wankel type engine as in the U.S. Pat. Nos. 3,228,183, 4,308,002, 5,305,721, and a continuous combustion engine as in the U.S. Pat. No. 3,996,899. Most rotary engines, and particularly the Wankel and those described in the U.S. Pat. Nos. 3,442,257, 3,614,277, 4,144,866, 4,434,757, DE Patent No. 3,027,208 are based on the principle of volume variation between a curve and a moving cord of fixed length as a single sliding piston and have the common disadvantage of not being balanced.

### SUMMARY OF THE INVENTION

The objective of present invention is to provide an engine or fully balanced cycling volume machine with variable shape rotor and low internal friction. It is also an objective to provide a rotor engine with reduced negative effect of the centrifugal forces on the oil or lubricant distribution and utilize a conventional oil pan (pool) design solution proved to be superior to other types of lubrication systems, particularly the ones used in conventional automobile engines. Still another objective of present invention is to create an effective and simplified engine sealing system.

It is another object to create possibility of using a simple circular shape stator and an efficient combustion chamber. Another objects are to create a system for direct and linear transmission of mechanical torque from all four pistons to the shaft, remove roll cams and pivoting parts from the action of combustion gases, reduce the weigh of the engine and provide cleaner exhaust. Still another object is to provide engine configuration capable of creating a jet propulsory system and creating an engine for water crafts employing polymer plastic or composite parts cooled directly in the water.

Another object of this invention is to provide a lower rpm engine, utilizing more efficient and less NOx producing (asymmetric) pressure cycle. i.e. giving less time to the compression and exhaust strokes, and allowing more time to the combustion stroke. Another object of this invention is to provide lower dead time, and to provide an engine tolerant to different fuels as well suitable for photo-detonation mode and hydrogen combustion.

Alternatively another objective is to create an ignition device amplifying the internal pressure during compression cycle to the point of ignition of air-fuel mixture and to provide an external combustion engine utilizing compressor and expansion machines as per present invention.

The rotor as per present invention comprises of an assembly of four pistons or blades suitable for creation of variable volumes during its rotation cycle and having sealed gaps between themselves and an oval or circular shape stator, where the opposite pistons are pivotally linked to each other creating parallelogram mechanism and where (in basic configuration) the crossings of said links are connected to the rotor shape deforming mechanism and are also coupled with the output shaft.

The pistons can have individual seals with stator and side covers creating variable volume chambers or have seals between them, preferably at the centers of their relative rotation. The variable chambers can be composed as shown in the drawings and diagrams below. Intake ports, spark plug and exhaust ports are provided either radial in the stator housing, or axial in the side covers, or both.

Different sealing techniques are further presented where sealing between pistons and side walls of the stator generally constitute simple linear or curved semicircular spring loaded seals similar to the Wankel type engine seals. Apex seals are arranged either between pistons, or between pistons and stator contour circular or oval wall, or comprising additional seals supported in the mid angle between adjacent pistons and having apex seals with them. Another type of continuos seal when used in combination with toroidal shape stator are also disclosed as well as seals employing rollers and supporting roll bearings at the ends of the pistons.

Rotation of the rotor provides the pistons of the variable rotor to generate cycling volumes thus enabling to provide compression, expansion or vacuum. The engine with four pivoting pistons would have four strokes cycle firing four times per every revolution, with virtually no dead time.

### BRIEF DESCRIPTION OF THE DRAWINGS

The following drawings illustrate specific details of present invention.

FIGS. 1, 2, 3, 5, 6, 13 show one preferred embodiment employing four segmental pistons arranged in lozenge configuration.

FIGS. 4, 12, 14 illustrate the same embodiment with pistons arranged in a square configuration.

FIGS. 7-10 illustrate prior art.

FIG. 11 is a cross section of the engine from FIG. 12.

FIG. 12 shows plan view of the preferred embodiment with part of the engine side cover not shown.

FIG. 15 details the extreme positions of the links between pistons relative to the piston during engine operation, and FIG. 16 provides a cross section of the piston side wall in assembly with its side wall.

FIGS. 17, 23, 27 illustrate engine configuration with lubricating oil pan (pool) and pistons aligned in a square configuration and surrounding the stator.

FIGS. 22, 26, 29 show the same engine with pistons arranged in a square configuration.

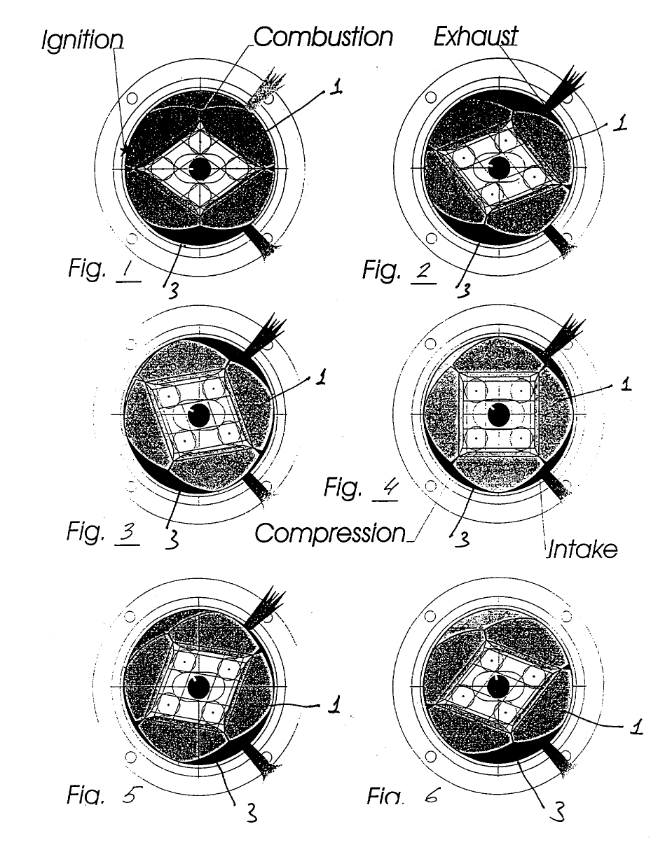

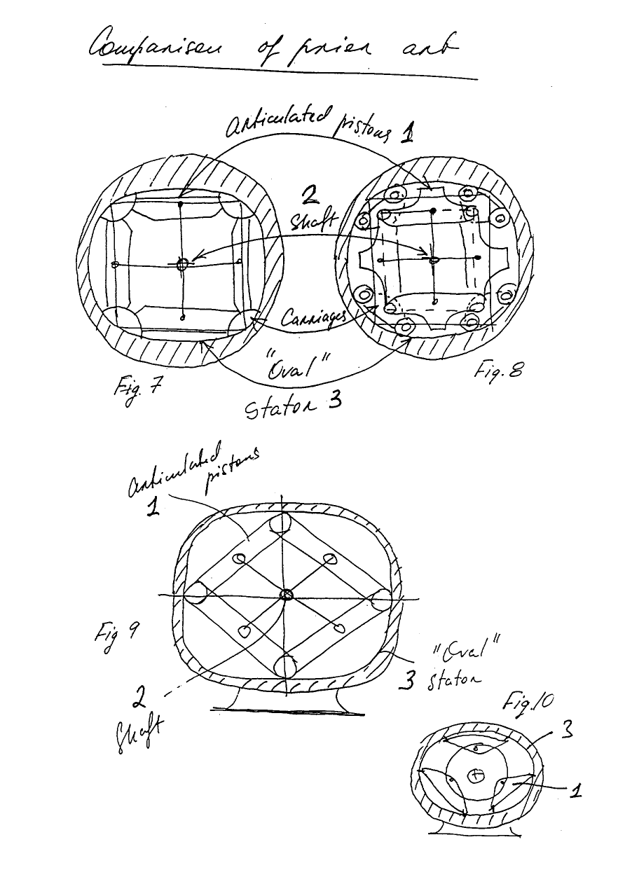

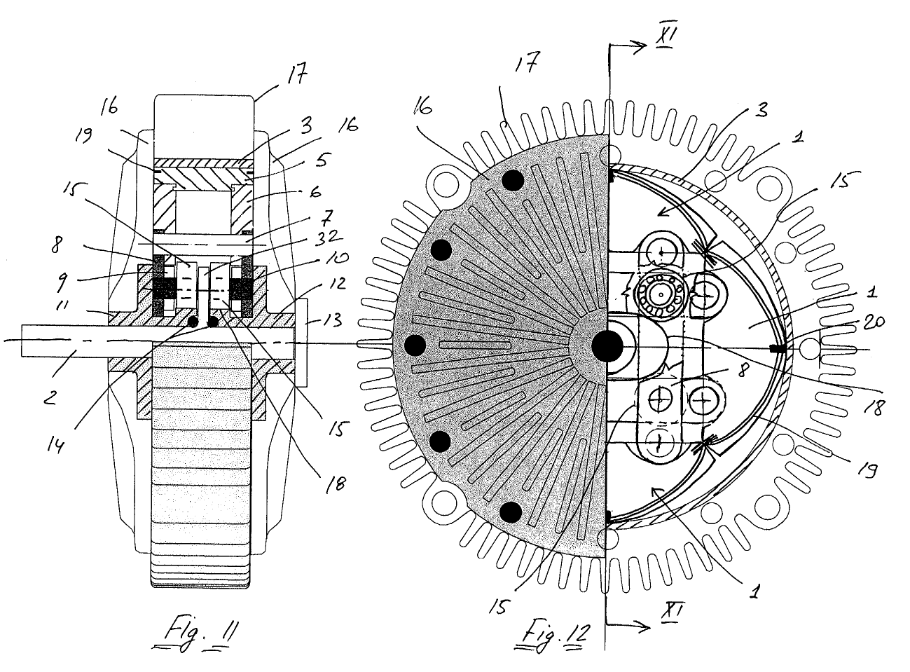

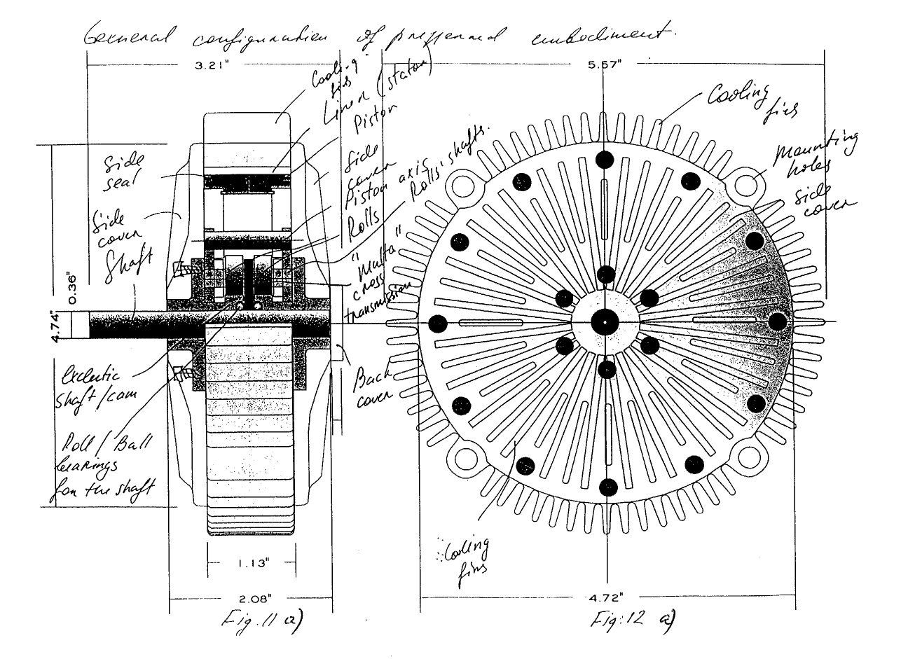

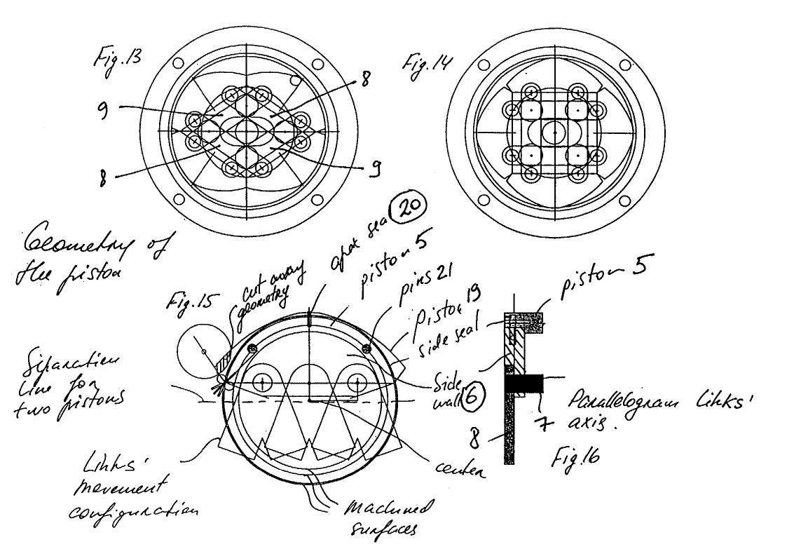

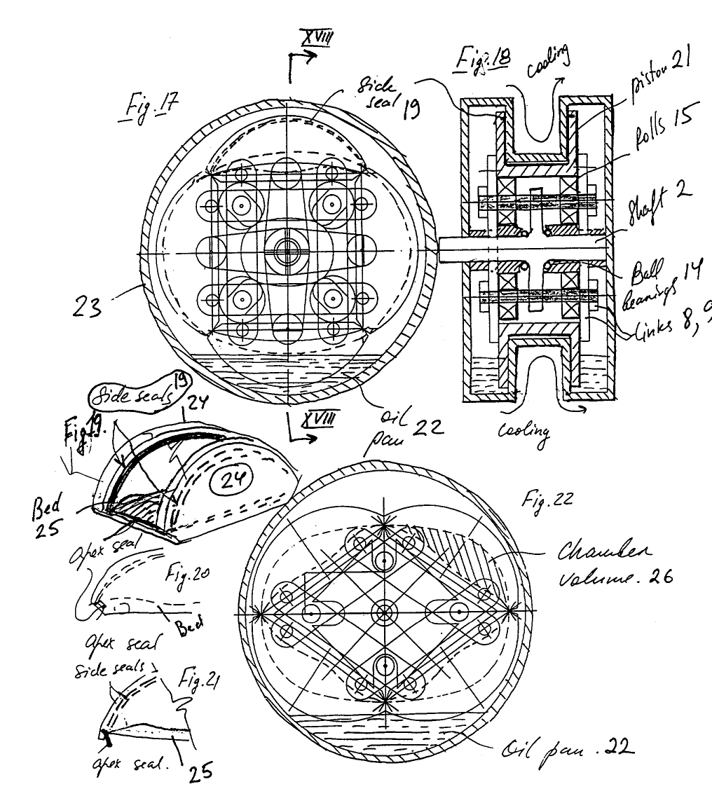

FIG. 18 is a cross section of the engine as per FIG. 17.

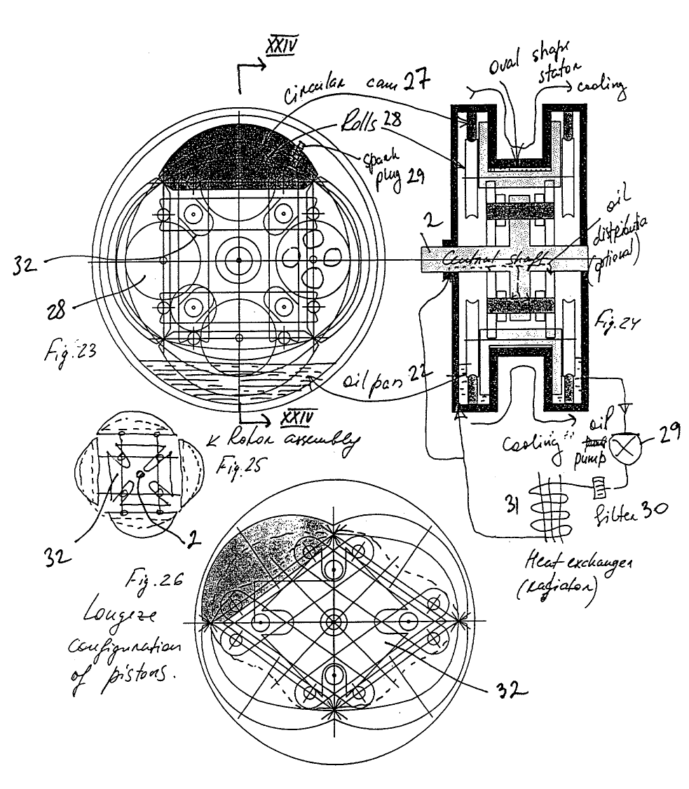

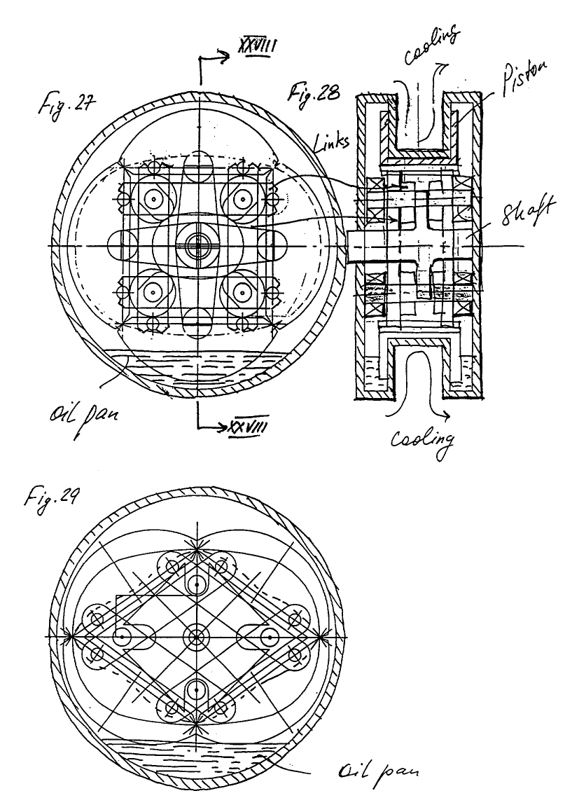

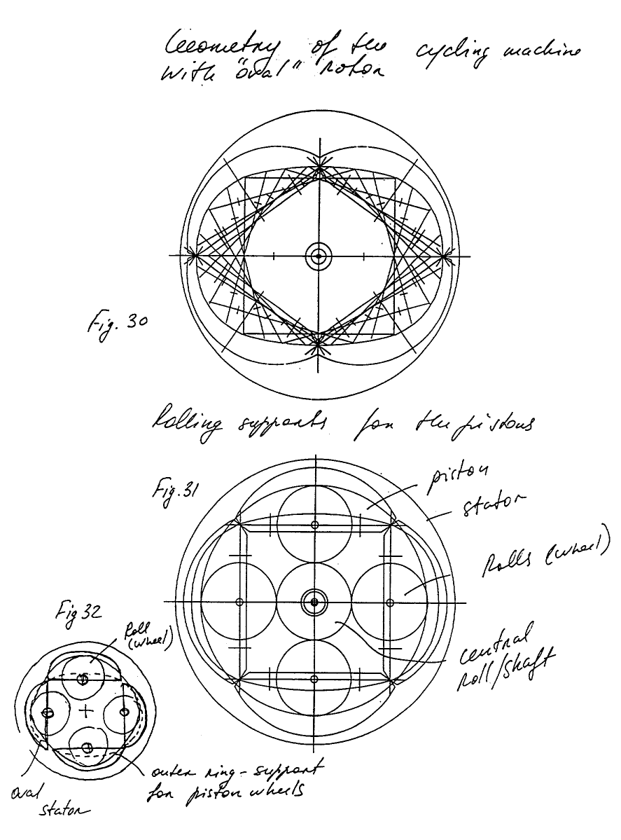

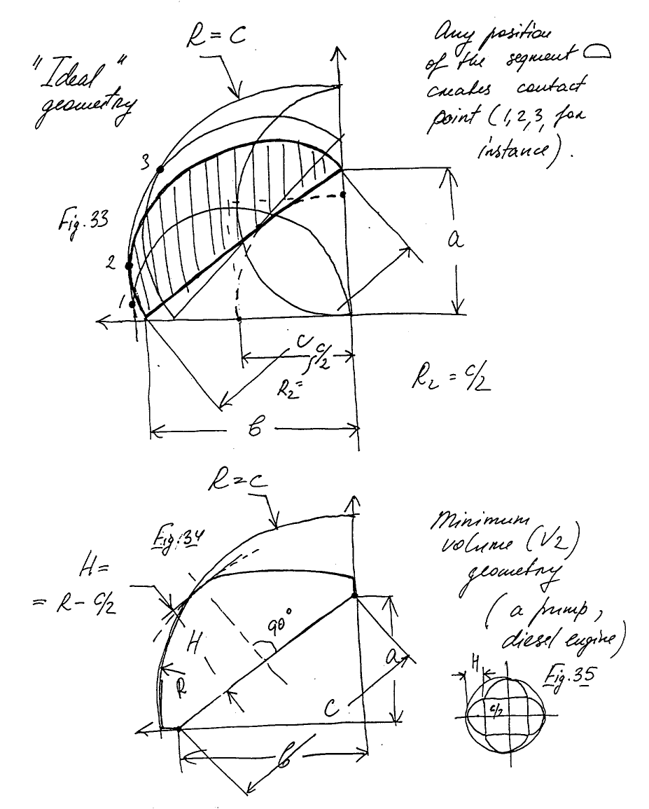

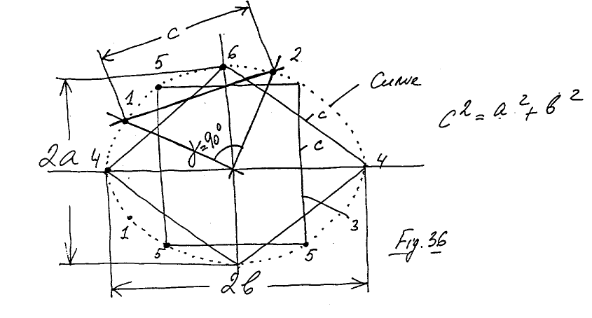

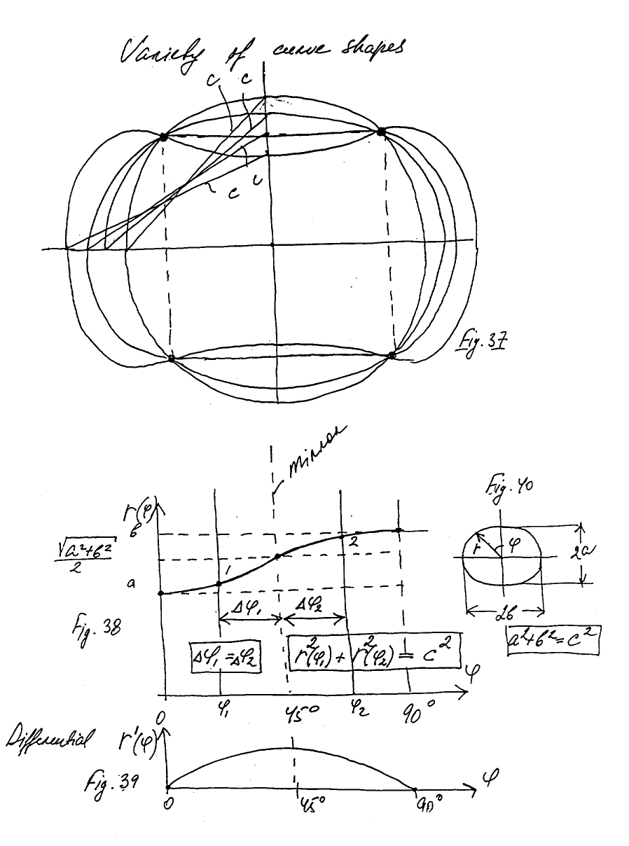

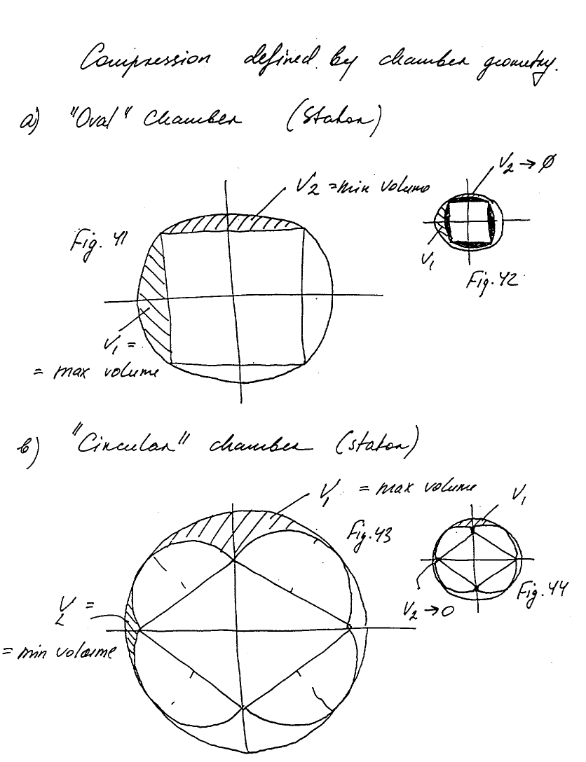

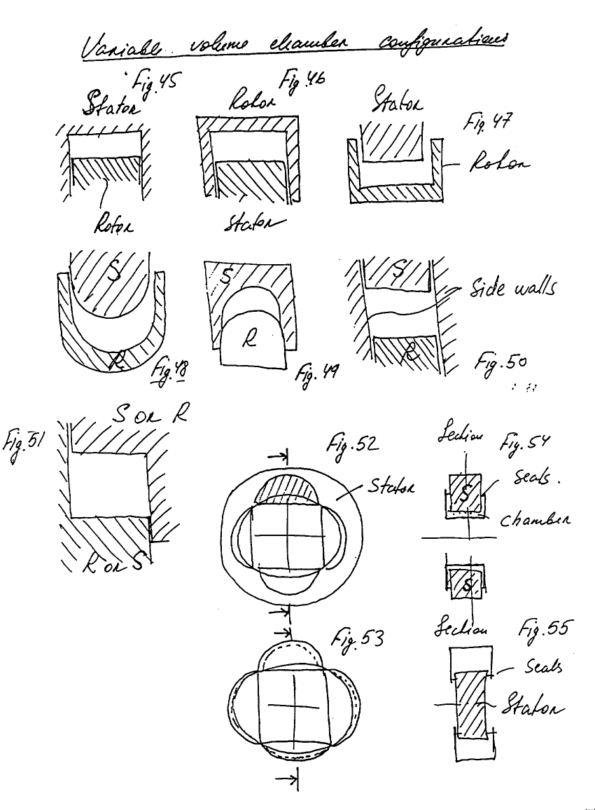

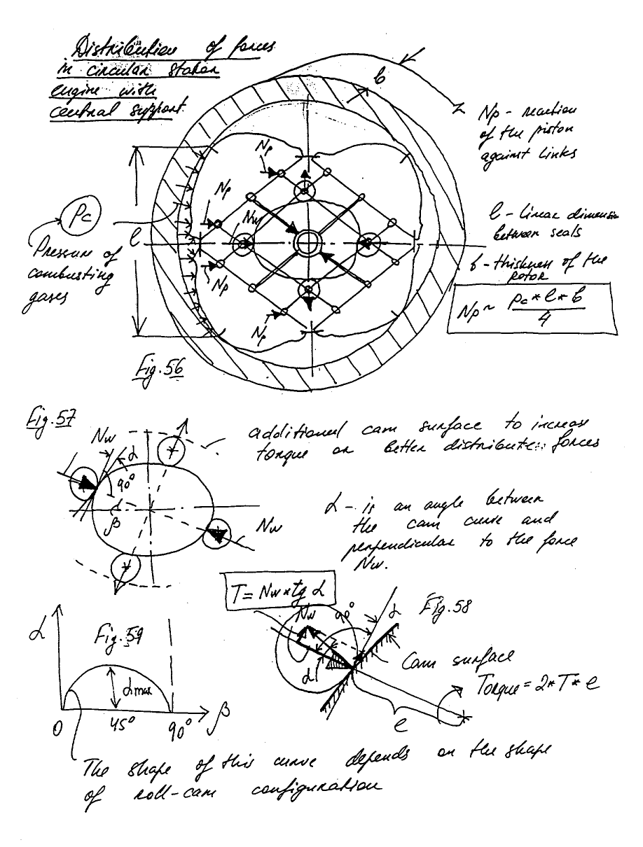

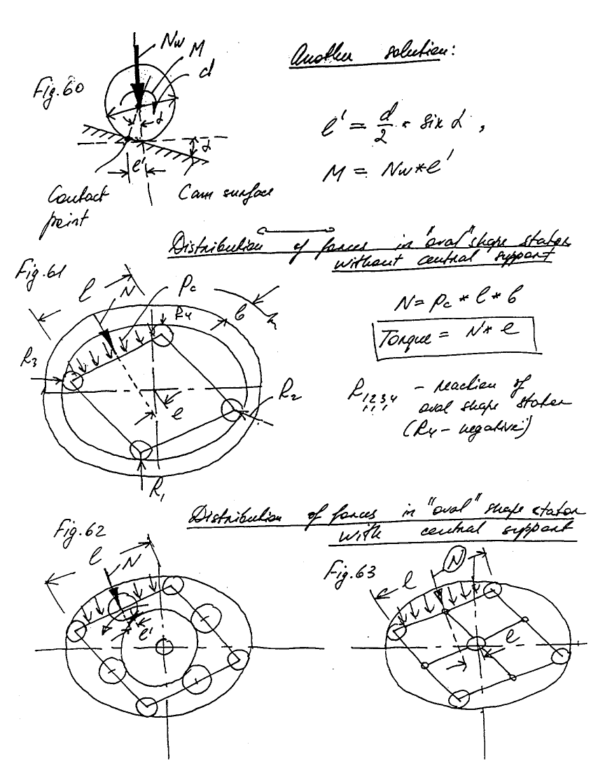

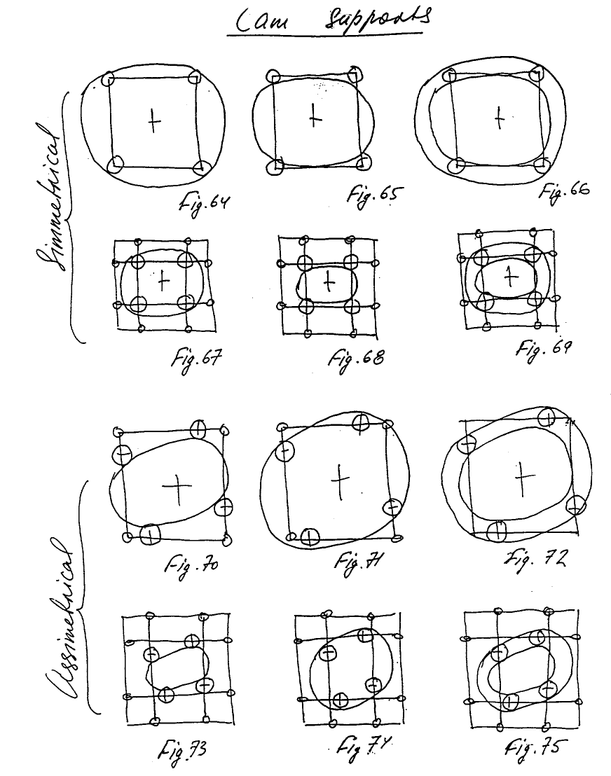

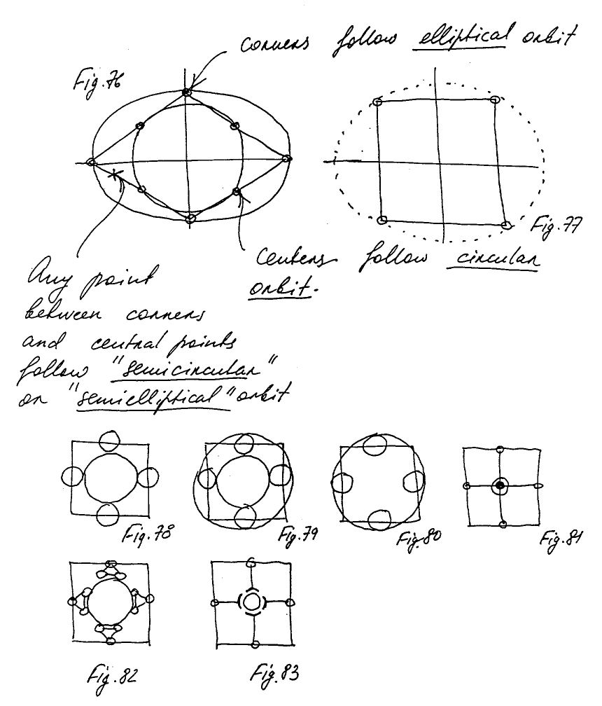

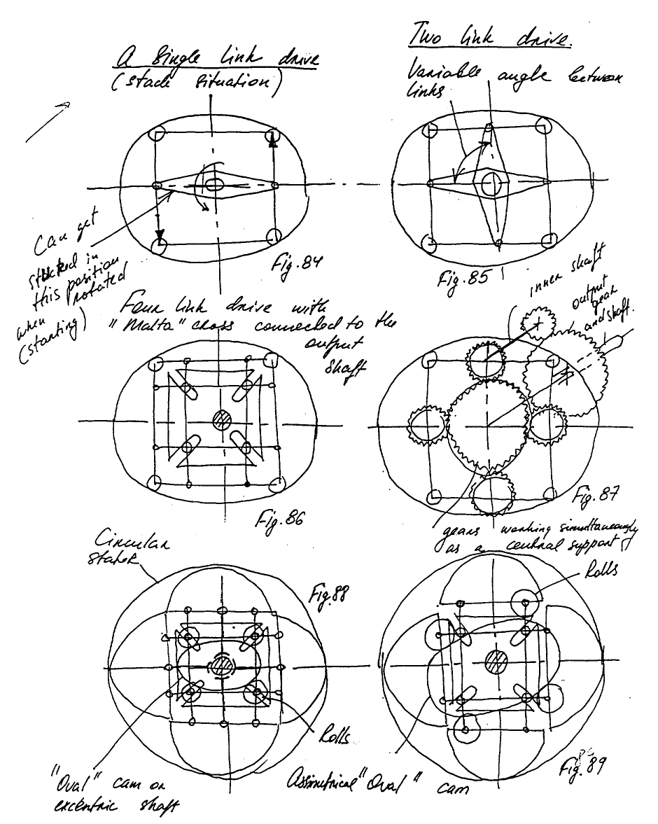

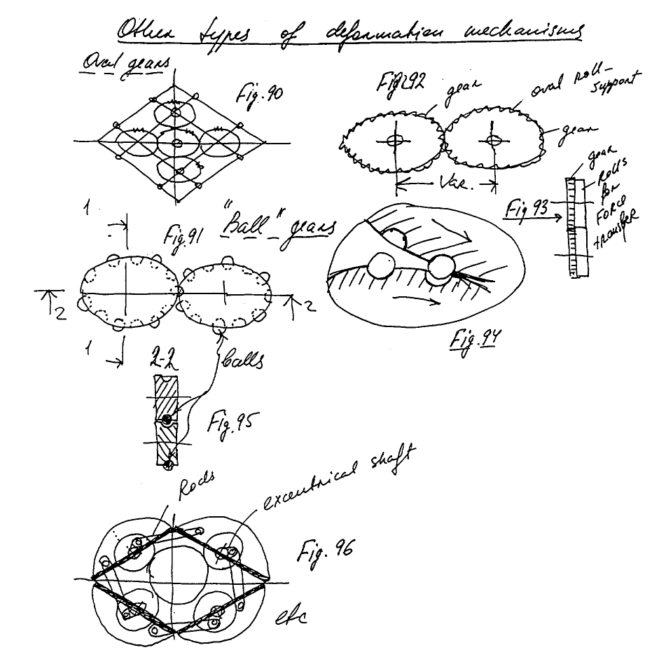

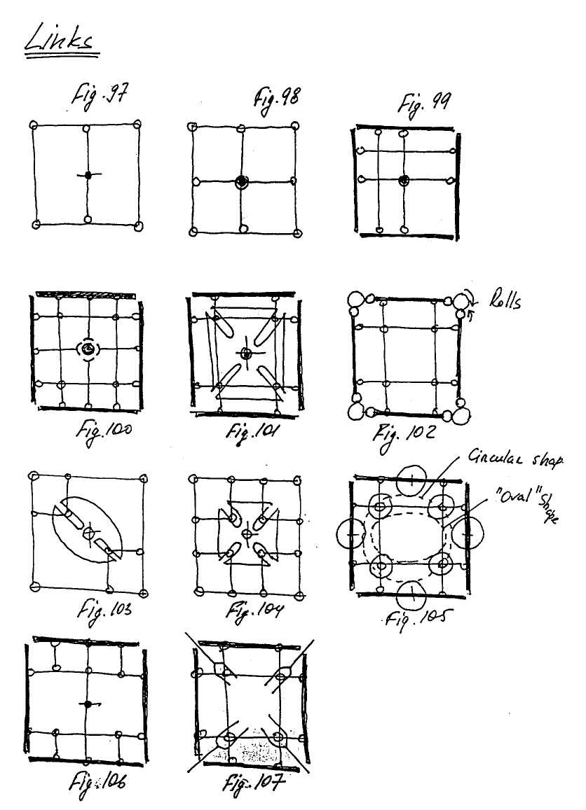

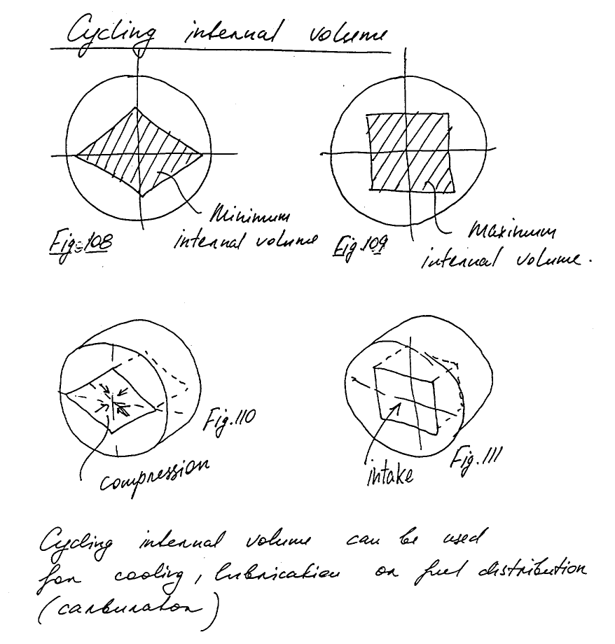

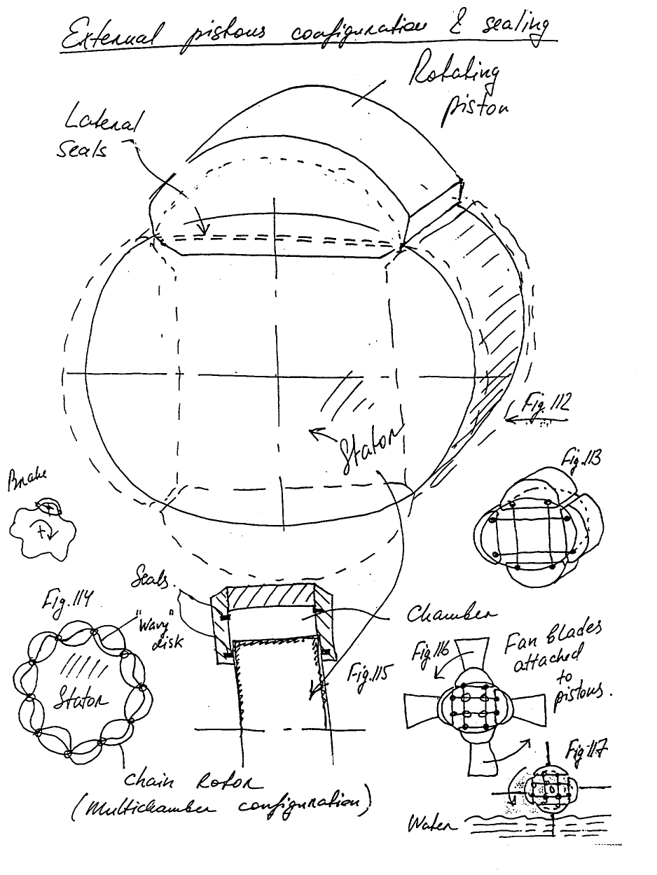

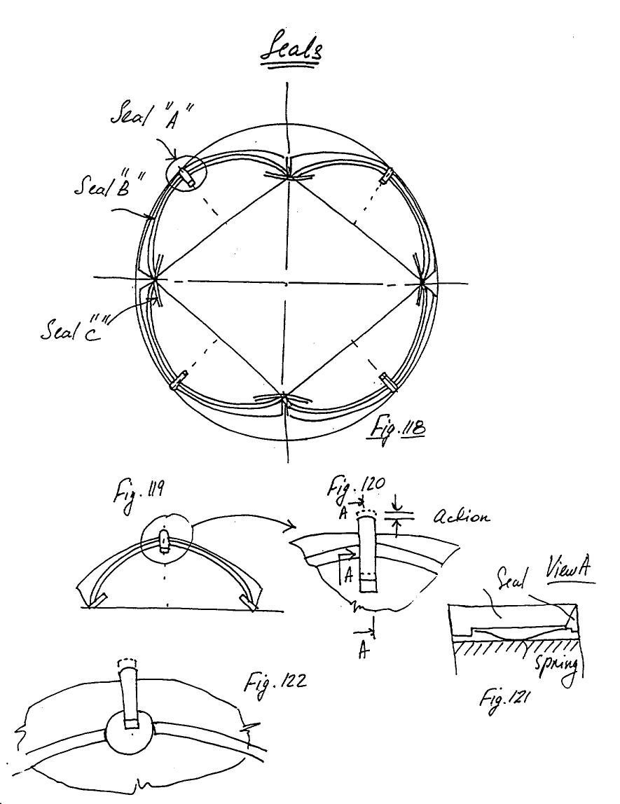

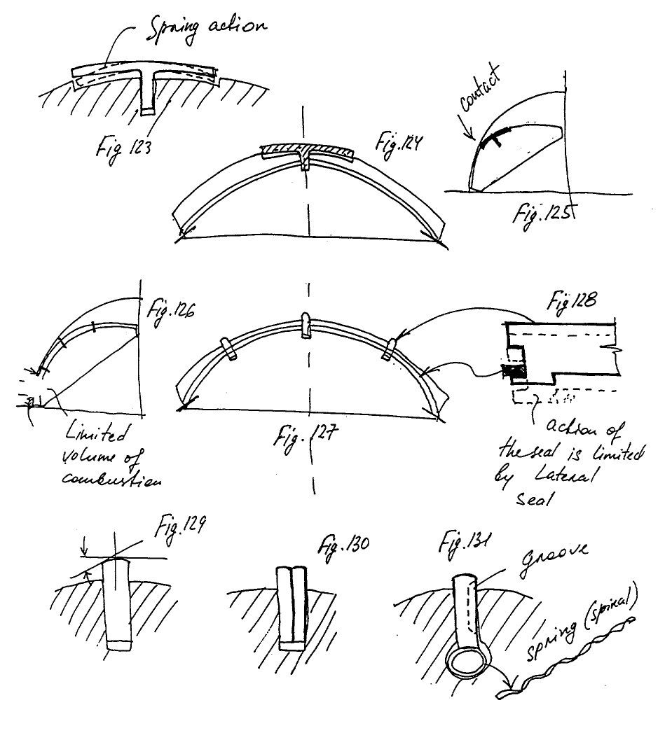

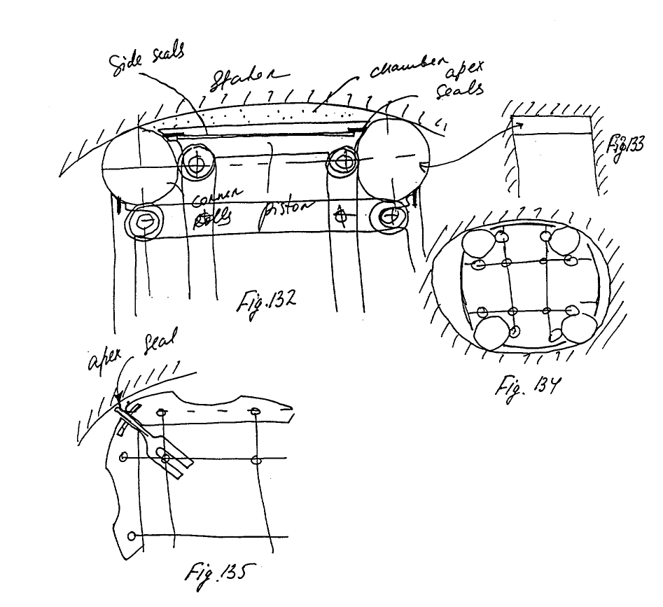

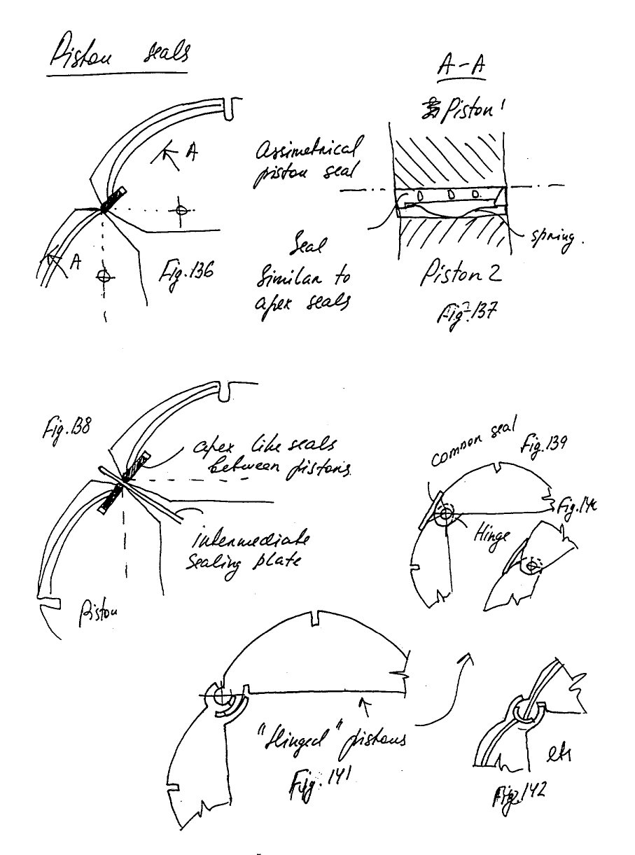

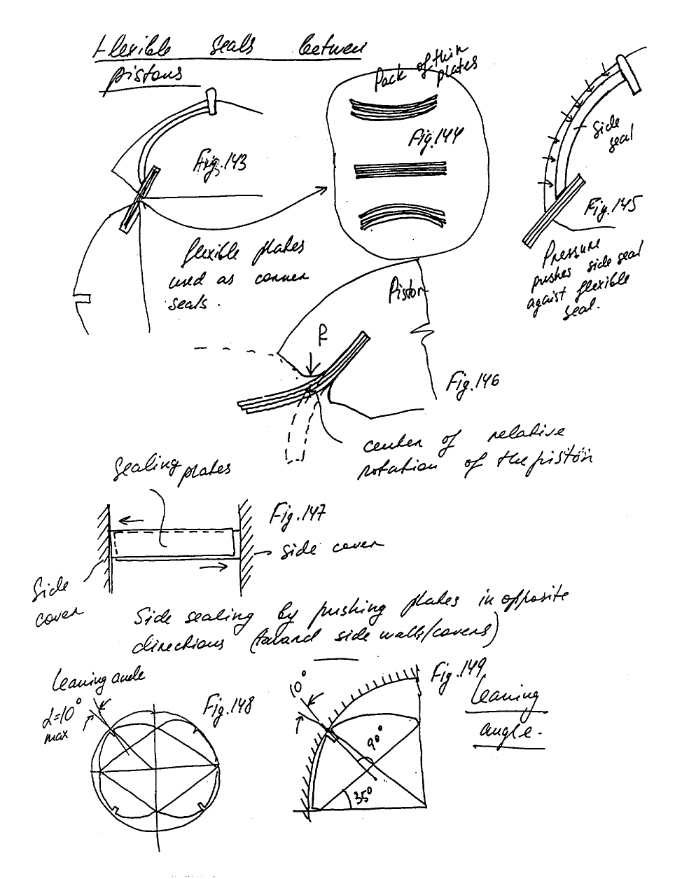

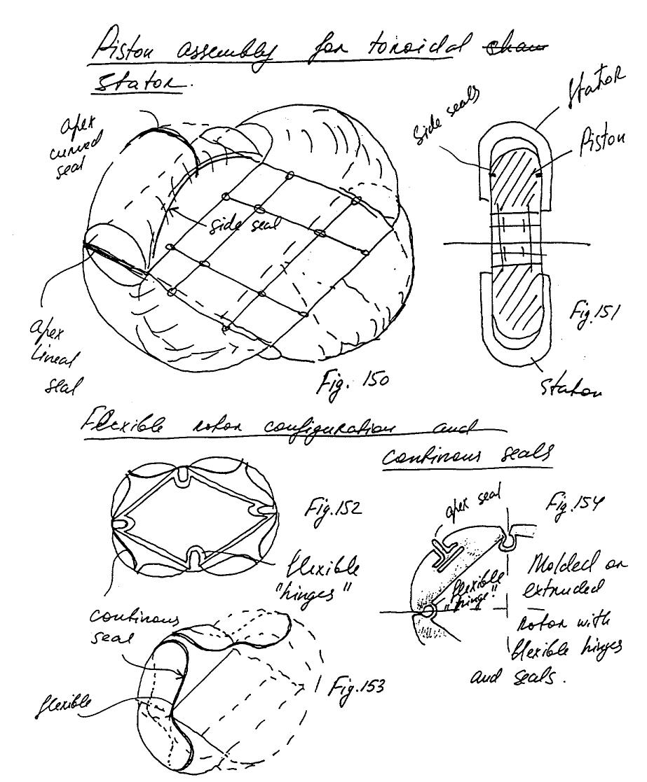

FIG. 24 is a cross section of the engine as per FIG. 23.

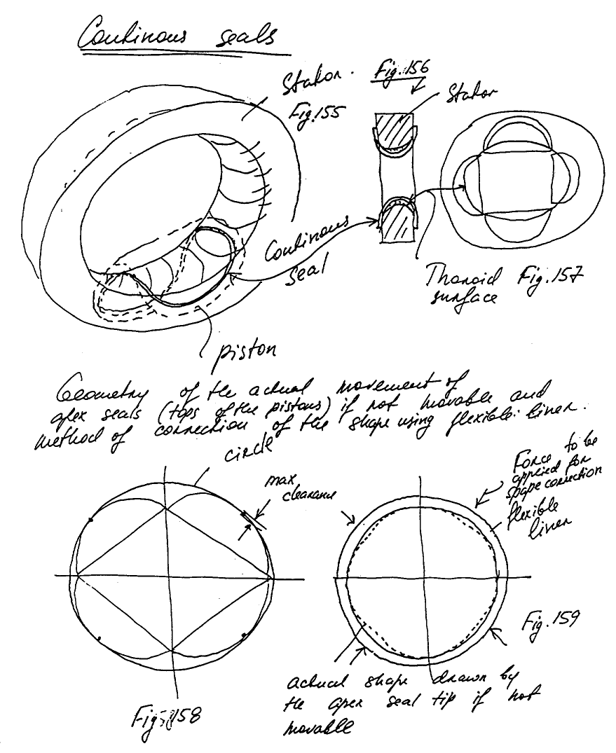

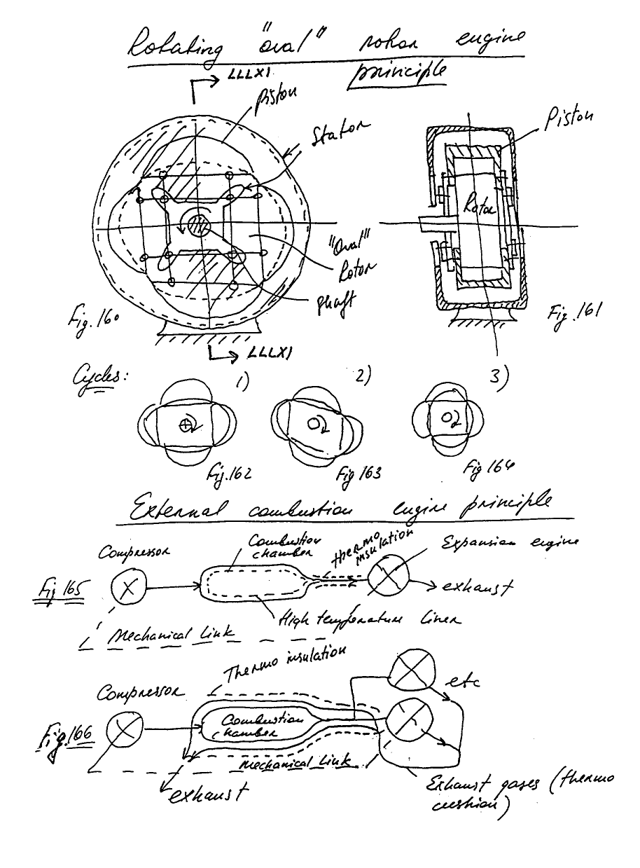

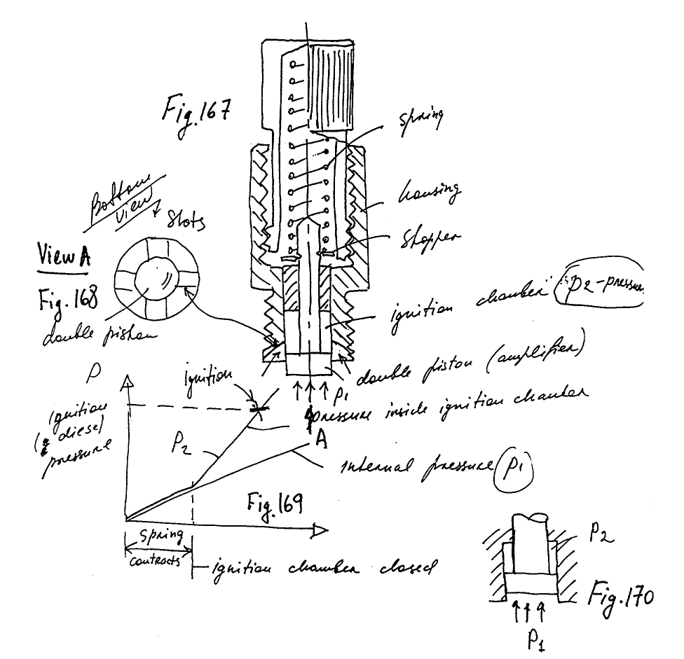

FIG. 28 is a cross section of the engine as per FIG. 27.

FIGS. 19-21 illustrate details of the sealing with side seals positioned in side covers and “apex” seals at the edges of the bed.

FIG. 25 shows kinematic scheme of the engine as per FIG. 23.

FIG. 30 details geometry of the cycling machine with “oval” shape stator.

FIGS. 31 and 32 illustrate pistons with supporting wheels (rolls) positioned in the central part of pistons.

FIG. 33 illustrates the geometry of the circular stator shape and “ideal” segmental pistons.

FIGS. 34 and 35 provide the geometry of segmental outer portion of the piston creating minimum volume between pistons and a contour wall.

FIG. 36 illustrates method of determining of the geometrical shape of the contour wall of “oval” shape.

FIG. 37 illustrates variations of possible shapes of “oval” contour wall.

FIGS. 38-40 provide illustration to the method of finding mathematical solution for the definition of contour wall curve.

FIG. 41, 42 provide diagrams of minimum and maximum volume of chambers for “oval” type contour wall.

FIGS. 43, 44 provide diagrams of minimum and maximum volume of chambers for circular type contour wall.

FIGS. 45-55 show a variety of rotor and stator configurations determining the shape of the cycling volume chambers.

FIGS. 56-63 describe principles of determination of engine internal loads and torque.

FIGS. 64-75 show a variety of cam mechanisms for piston rotor assembly shape deformation.

FIGS. 76-83 illustrate different types of supports for pistons capable of direct receipt of loads from variation of chamber pressures.

FIGS. 84-89 present different systems for mechanical transfer of the torque to the output shaft, where FIGS. 84 and 85 describe prior art and illustrate its disadvantages.

FIGS. 90-96 are other illustrations of the methods of deformation of piston assembly utilizing oval gears coupled with oval rolls, and the devices with crank shafts.

FIGS. 97-107 show a variety of possible pivoted links between pistons.

FIGS. 108-111 are demonstrating details of variation or cycling of internal volume between pistons.

FIGS. 112-117 present in greater details engines or compressors with pistons surrounding the stator or rotor, particularly FIG. 114 illustrate a piston or a chain of pistons surrounding a “wavy” stator or rotor and FIGS. 116-117 present the variant of engine with blades or fins associated directly with pistons.

FIGS. 118-157 illustrate in great details different types of seals, sealing methods and embodiments.

FIGS. 158-159 show a variant of the device with circular deformable contour wall of flexible liner of the stator.

FIGS. 160 and 161 illustrate rotary engine with “oval” shape rotor and stationary piston assembly.

FIGS. 162-164 further show the cycling sequence of such device.

FIGS. 165-166 describe principle of external combustion engine as per present invention,

FIG. 167 describes an amplified compression type ignition plug and method of amplified pressure ignition.

FIG. 168 present a bottom view of the plug showing slots for gas passage, and

FIG. 169 provides explanation to method of amplification of pressure inside ignition chamber of the plug by means of differential piston presented in the FIG. 170.

### DETAILED DESCRIPTION OF THE PREFERRED EMBODIMENT

Preferred embodiment comprises a four pistons (each generally of the in a form of a disk segment) variable shape assembly where pistons are linked to each other creating a parallelogram mechanism by means of at least four pivoted links. The pistons are movably mounted inside the engine housing comprising side walls and a stator of generally circular or semicircular inner profile thus providing a contour wall. (This shape can also be achieved by using rigid or flexible (deformable) cylindrical liner, which in addition can be deformed to match its configuration to the ideal geometry of movement of the pistons and apex seals.)

The shape of the rotor assembly is alternatively changing from lozenge to square with the help of the piston assembly deformation mechanisms which can be for instance a cam mechanism having roll/s with its axes corresponding to the intersections of the pistons links and rocking against the “oval” shape or generally speaking about non-circular orbit.

Diagrams of operation of the cycling volume machine as a four cycle internal combustion engine are further presented in the drawings. It is important to mention that the engine can operate as a two cycle engine where two intake ports and two exhaust ports can be provided. Alternatively the inner cycling volume of the engine (between pistons) or external blower also can be utilized for fuel mixture compression or distribution or as part of the lubrication system, cooling, porting, etc.

A distinct advantage of the engine as per present invention is the fact that piston assembly deformation mechanism is actually not a part of the contour wall or stator or rotor configuration which makes it easy to adjust its properties to different types of fuels, desired compression ratios and ratios between the combustion/intake/expansion chambers volumes and angles of the rotor assembly rotation, thus providing greater flexibility to the design of the device and providing reduction of its cost.

Each piston's height can be approximately equal to the half of its length which provides minimum variation of the clearance between the top of the piston and contour of the stator circular wall. For instance, with stator inner diameter 4″ (˜100 mm) the length of the piston can be 2.13″ (54 mm) and the height-0.9,″ (23 mm) and the variation of the gap between the top part of the of the piston (at its apex seal) will be in a range of 0-0.012″ (0-0.3 mm.) This small variation or apex seal normal breathing can be easily accommodated by its sliding in the seat.

The “ideal” geometrical configuration will involve piston segments of twice less radius than the stator contour wall and with any configuration of the piston assembly it will be always a precise contact between the piston's outer circular part and the circular contour wall of the stator. Sealing will be a challenge though with respect to this configuration, however in the high rpm devices the “close to zero” gap technique can be employed where depending on the density of working fluid very sufficient pressures can be achieved without seals at all, but with minimum clearance between parts. This particular configuration will be preferable with ceramic, composite or plastic parts employed which can be especially advantageous for “lubricant free” engines as well as in “micro” engines etched from the silicone based materials, etc.

In its preferable configuration the apex and side seals are similar to the Wankel type seals with the advantage of having much more favorable leaning angle of apex seals (not more than 10 degrees compared to between 16 to 30 degrees for Wankel type engines.)

The geometry of other variations and details of engines and cycling volume machines is described in the diagrams enclosed herein. The variations of shapes of the “oval” stator or geometry of the cam surfaces and other parameters are numerous and can be analyzed using standard math analysis techniques. The geometry chosen will determine the compression ratio and displacement of the engine. The shape of the curve always has to conform with two points: #1 and #2 (see FIG. 36), the distance between them has to be equal to the side of the square 3(c), and a polar angle (gamma) between them must be equal 90 degrees. Such curve has an indefinite amount of solutions (shapes) predetermined by the ratio a/b and by at least one fragment of the curve between points 4 or 5 and 6 which are the reference points for all possible curves with similar ratio “a/b”. However, points 5 still remain common reference points for all possible curves.

Compression ratio of present engine is not limited by its geometry, contrary to the Wankel type engines where it cannot exceed 15.5:1 (for three lobes rotor.) Displacement of engines as per present invention has to be compared to eight cylinder four cycle engine, as it will have equal number of power strokes per one shaft revolution. As an example, the circular stator shape engine as per present invention with displacement 2.7 liters will have diameter of the contour wall of approximately 12″ and thickness of 3.3″ only.

The central shaft can be linked with at least two opposite pistons in a way described in a prior art, i.e. by a coupling arm or two arms. However, as the angle between arms changes during the rotation this method will prove difficult to implement in terms of equal distribution of the torque from all four pistons. Another disadvantage of such solution will be an alternative difficulty of rotating the shaft during the starting procedure due to possibility of cam rolls getting stuck when approaching lean angles with the cam surface, especially in case of engines or compressors with higher compression ratios.

As per preferable embodiment the central shaft has a cross-like shape with four slots engaging with corresponding axes of the parallelogram links at their crossings. Thus, either the torque can be transferred to the output shaft alone, or both: the torque and the lateral force resulting from the internal chambers' pressure can be transferred through the pistons depending on the configuration chosen.

While the cam mechanism itself can withstand these lateral forces and provide creation or the torque, it is more advantageous to separate these two functions as it is shown in the preferred embodiments. Several means as illustrated can be employed for such configuration including pivoted arms, rolls, etc. This solution will also provide better dynamical response to the pulsating loads received during the power cycles and improve torque creation and transmission system.

Because the duration of peak pressure at the top dead center is much shorter than in the conventional piston or Wankel type engines, the shape of the combustion chamber is much less critical. It can be assumed however that the least total surface area of the combustion chamber will be desired in order to improve thermal efficiency of the engine. Two spark or glow plugs can be employed similar to the approach used in Wankel type engine in order to improve combustion.

Intake and exhaust ports can be located in the side covers or in the stator or rotor, or in both. In order to simplify the design, laminated structure for the stator or rotor or both can be employed. Intake and exhaust ports can then be provided in a form of slots or bunched openings provided in the plates (lamellas) which, after putting them together and tightening or sintering, will provide internal channels as well as any desirable outer or inner shape configuration.

Distribution of the wear and heat will be expected to be quite similar to the Wankel type engine with more sealing capabilities for the apex seals due to the lower lean angles of the seals.

The engine with “oval” stator configuration can be provided with different types of chamber compositions. The preferred embodiment includes a stator ring with pistons surrounding it from the inner or outer portion of the stator ring. In case of inner position of the pistons it becomes possible to employ a conventional oil pan (oil pool) for lubrication which significantly simplifies the overall design, improves reliability and provides low emissions.

The number of pistons surrounding stator can vary from application to application with minimum four pistons employed. A “chain” like structure can be achieved with multiple chambers or a “wavy” disk coupled with a single or multiple tiltable chamber/s. This configuration can be effectively used in pumps, pneumatic brakes for vehicles (a pump with closed output and “wavy disk” like stator), propulsors for water crafts etc.

In case of water craft engines, the parts can be made of polymer plastic/composite and the whole engine can be submerged into the water for effective cooling. Each piston can have a blade attached for it for direct propulsion. The same configuration can be used for airplanes or ducked fan engines.

Continuous seals are also described herein in combination with toroidal stator or toroidal shape rotor pistons. These seals are as high effective as conventional piston engine seals. In addition, the “one piece” molded, extruded or etched rotor assembly with flexible seals is shown.

In the instance of four stroke combustion engines, the four chambers can be used in a close circuit and the cycles are defined as follows: intake-compression-expansion-exhaust. Ports for intake can utilize a conventional carburetor or can be fitted with gas or diesel fuel injector. Alternatively, the fuel can be injected directly into the chamber. Also a continuous combustion can be achieved by utilizing a flame pilot technique or providing a channel between chambers. Alternatively, the compression diesel igniter can be used as per preferred embodiment where the pressure of air/fuel mixture is mechanically multiplied by differential piston as per diagrams below.

Effective ignition timing advance can be achieved by using electronic ignition or controlling the injection of fuel directly into the combustion chamber. A spark plug cavity can be exposed to the inner volume of the combustion chamber by means of porting by rotating pistons themselves.

The engine as per preferred embodiment does not require a fly wheel as the inertial capability of the four piston assembly is sufficient for providing smooth rotation even on low rpms. Projected highest rpm of the engine is about 3000-5000 rpm due to four firings per revolution which in many cases will require less complicated gear box or no gear box at all.

Cooling of the engine can be done by air, water or oil in a traditional for rotary (particularly Wankel type) engines way. In case of employment of oil pan the intensive circulation of the oil utilizing an external heat exchanger for cooling and filter can be provided. Inner variable volume of the engine also can be used for pumping the cooling agent or fuel mixture into the engine. Alternatively, the cooling and/or lubricating systems can employ simply a mixture of the oil with fuel as well as more complex distribution systems. One of the systems include an intake port opening connected with carburetor through the inner volume of the rotor which can provide effective cooling of the links and pistons by the intake air and/or fuel. The inner volume can be furnished with valve/s for providing pumping/vacuum capabilities to it.

The engine as per present design can work as an expansion type machine with numerous types of fluids like steam, compressed/liquified gases, hydrogen and solid fuel burners, etc.

As further illustrated in FIGS. 165, 166, two cycling machines as per present invention can be arranged in a such way that one machine will compress oxidizer (air, for instance) and deliver it along with fuel into a high pressure combustion chamber where the products of combustion will be fed into expansion machine as per present invention and part of the energy created can be fed back to the compressor. The similar configuration of external combustion engine can employ a hybrid system where the compressor can be driven by electric motor, etc. it is important to note that practical devices described and provided herein are for illustrative purposes only and should not limit the scope and intentions of present invention.

I claim:

1. A rotary cycling machine able to produce mechanical energy from pressurized fluids as well as to pump, vacuum and compress fluids, and comprising:
a cylindrical hollow housing having an internal contour wall and having two plane side covers parallel to each other and perpendicular to the housing central axis;
an assembly of four linked pistons protruding between said side covers and articulating one to the other about parallel axes at the ends of the pistons and where opposite pistons remain parallel to each other during this articulation;
the assembly of said four articulating pistons rotating inside said housing contour wall about said central axis and where said four axes of the piston assembly have cycling trajectory orbiting said central axis;
said pistons carrying seating means between them, apex sealing means between each of them and said contour wall and a system of lateral sealing means in conjunction with them and said plane side covers;
four chambers of variable cycling volume, each defined by the internal contour wall, two side covers and the adjacent parts of each piston with said sealing means between them positioned within said volume;
a set of ports in the said housing or side covers or pistons for either intake, exhaust, lubrication or cooling or any combination of such;
wherein the shape of assembly of said articulating pistons during one revolution is changing from lozenge to square and back to lozenge at least once and;
wherein the outer radial shape of each piston when the assembly of pistons is in lozenge configuration is generally conforming the shape of the internal contour wall so that the said chamber between two adjacent pistons has minimum volume and is defined in a desirable way, and when the said assembly of pistons is arranged in a square configuration the mid apex part of each piston has the least distance to said contour wail and said chamber between two adjacent pistons reaches its maximum volume.

2. A cycling machine as defined in claim 1 where said articulating piston has shape of a segment with outer curved portion facing said contour wall.

3. A cycling machine as defined in claim 1 where said sealing means comprise at least one of the following: single or multiple plates or curved strips, flexible members, rolls, spring loaded sliding gate type seals or tight tolerance small gaps between the adjacent moving or rotating parts.

4. A cycling machine as defined in claim 1 wherein said assembly of articulating pistons comprises a single piece with flexural pivots and sealing means and is preferably made by methods of extrusion or etching.

5. A cycling machine as defined in claim 1 wherein the said housing contour wall is generally shaped like a circle.

6. A cycling machine as defined in claim 1 wherein the said housing contour wall can be deformed in its radial direction providing equal number of areas of maximum curvature and intermediate areas of minimum curvature.

7. A cycling machine as defined in claim 1, wherein each piston has more than one apex sealing means spaced apart along the outer radial portion of the piston and facing the contour wall.

8. A cycling machine as defined in claim 1, further comprising:
at least one pair of two parallel to each other and pivotally interconnected with each other at their intersections rods with pivots at their free ends connected to said four pistons;
a central shaft coaxial with said central axis and having a coupling mechanism with said piston assembly comprising a radial member preferably connected to at least one pivoting intersection of said rods by traction slot in a such manner so that the radial cycling movement of the pivoting crossings of the rods remains possible;
at least one cam mechanism providing at least one maximum and at least one minimum distance between its surface and the said central axis, connected to at least one of said side covers and having at least one roll rocking against the said cam surface and connected to any portion of said assembly of articulating pistons or said rods at the point which has an oscillating orbit against said central axis and preferably through the pivoting intersection of said rods.

9. A cycling machine as defined in claim 1 wherein the cycling inner volume defined between said articulating pistons and said side covers is used for creation of an additional flow of fluid for cooling, mixing, lubrication, fluid re-distribution or other purposes or combination of such.

10. A rotary cycling machine able to produce mechanical energy from pressurized fluids as well as to pump, vacuum and compress, and comprising:
a cylindrical housing having a contour wall with two plane sides parallel to each other and perpendicular to the housing central axis;
an assembly of at least four pivotally linked with each other beds with side covers surrounding said two plane sides of the contour wall and articulating one to the other about parallel axes at their ends;
the assembly of said articulating beds with side covers rotating inside or around of said contour wail about said central axis and where said axes of the assembly of said linked beds have cycling trajectory orbiting said central axis;
said beds with covers carrying seating means between them and the contour wall with plane sides, namely sealing means between each of them at the ends of the beds and said contour wall and a system of lateral sealing means in conjunction with side covers of the beds and said plane sides of the contour wall;
number of chambers of variable cycling volume equal to the number of said beds, each defined by the contour wall, bed itself and its two side covers;
a set of ports in either said contour wall, its plane sides, or side covers of the beds or any combination of these used for intake, exhaust, lubrication or cooling purposes;

11. A cycling machine as defined in claim 10 wherein said contour wall has a semi-toroidal shape geometrically merged with plane side covers.

12. A cycling machine as defined in claim 10 wherein said seals comprises one continuous seal per one bed.

13. A cycling machine as defined in claim 10 where said sealing means comprise at least one of the following: single or multiple plates or curved strips, flexible members, spring loaded sliding gate type seals or high tolerance small gaps between the adjacent moving or rotating parts.

14. A cycling machine as defined in claim 10 wherein said assembly of articulating pistons is composed from a single piece with flexural pivots and sealing means and preferably is made by method of extrusion or etching.

15. A cycling machine as defined in claim 10, wherein the said housing contour wall is generally oval like shaped with at least two minimum and at least two maximum curvatures.

16. A cycling machine as defined in claim 10, further comprising:
at least one pair of two parallel to each other and pivotally interconnected with each other at their intersections rods with pivots at their free ends connected to at least four of said beds or their side covers;
a central shaft coaxial with said central axis and having a coupling mechanism with said assembly of beds or their side covers comprising a radial member preferably connected to the pivoting intersections of said rods by traction slots in a such manner so that the radial movement of the pivoting intersections of the rods remains possible.
at least one cam mechanism providing at least one maximum and at least one minimum distance between its surface and the said central axis, connected or being part of said contour wall or its plane sides and having at least one roll rocking against the said cam surface and preferably connected to the pivoting intersection of said rods or to any other point of articulating assembly of beds or their side covers which have a cycling orbit against said central axis.

17. A cycling machine as defined in claim 10 wherein the cycling or rotating movement of articulated beds or their side covers is used for splashing of lubricant or cooling agent from the pool.

18. A cycling machine or propulsor as defined in claim 1 or claim 10 where said exhaust ports have jet nozzles for acceleration and direction of the exhaust gases in order to create thrust.

19. A cycling machine as defined in claim 18 where said ports are opened with delay related to the moment of reaching by said variable volume chamber its minimum volume.

20. A cycling machine as per claim 1 or claim 10 where said contour wall and said ports are defined by edges of layers of plates combined with each other in a stack.

21. An external combustion engine comprising at least one compressor utilizing rotating articulated pistons or beds assembly with shaft and providing supply of compressed oxidizer or fuel or their mixture to the high pressure combustion chamber with exhaust for products of combustion.

22. An external combustion engine as defined in claim 21 where said exhaust connected directly or through heat insulated passage to the expansion machine utilizing articulated pistons or beds assembly.

23. An external combustion engine as defined in claim 22 where at least some mechanical energy produced by expansion machine is transferred back to said compressor shaft and the remaining part is used for a power output.

24. An external combustion engine as defined in claim 22 where said expansion machine is mounted directly in the vehicle wheel or other type of propulsor.

25. An external combustion engine as defined in claim 21 where said combustion chamber is similar to ones employed in turbojet or rocket engines capable of withstanding high internal pressures and temperatures.

26. An internal combustion engine as per claims 1 or 10 where each of said minimum volume variable chambers comprises at least one ignition device.

27. An engine defined in claim 26 where said ignition device comprises a cylinder with differential piston having the first end with greater square area exposed to the inner volume of said chambers and connected to a second end with lesser square area compressing the gas drawn from said chamber to a higher pressure and rising its temperature above the temperature of ignition.

28. A cycling machine as per claim 1 or claim 10 where said contour wall is of variable shape.

29. A rotary engine as per claim 1 or claim 10 where said housing has oil pan.
